(19) United States
(12) Patent Application Publication
(10) Pub. No.: US 2018/0169720 A1
(43) Pub. Date: Jun. 21, 2018

(54) SUBSTRATE COMPARTMENT CLEANING

(71) Applicant: Tec-Sem AG, Tagerwilen (CH)

(72) Inventors: Gerhard Dovids, Grabs (CH); Yves Fenner, Berg (CH); John Fiddes, Kreuzlingen (CH); Christian Wohanka, Tagerwilen (CH); Bernd Rahrbach, Konstanz (CH)

(21) Appl. No.: 15/843,206

(22) Filed: Dec. 15, 2017

Related U.S. Application Data
(60) Provisional application No. 62/435,697, filed on Dec. 16, 2016.

(51) Int. Cl. B08B 9/20; B08B 3/08; B08B 3/12; B08B 9/28

(52) U.S. Cl. CPC B08B 9/205; B08B 3/08; B08B 2209/005; B08B 9/28; B08B 2203/007; B08B 3/12

(57) ABSTRACT

A substrate stocker system that may include a high-density storage chamber that comprises a plurality of compartments, each storing one or more high density substrates, one or more robots configured to move one or more compartments of the high-density storage chamber for cleaning, and a cleaning module configured to clean the one or more compartments, while the one or more compartments hold corresponding one or more substrates.

This application claims priority from at least U.S. Provisional Patent Application 62/355,856, filed on Jun. 28, 2016 with docket number as TSGN-0001P and entitled “Substrate Storage and Processing”, and U.S. Provisional Patent Application 62/435,697 filed on Dec. 16, 2016 with docket number as TSGN-0007P and entitled “Substrate Compartment Cleaning”, which application may be incorporated herein by reference in its entirety for all purposes.

### FIELD OF TECHNOLOGY

This disclosure relates generally to substrate storage and processing. In one example embodiment, to a cleaning method system or apparatus for substrate and processing storage or buffering containers or compartments. More specifically, to a storage system, apparatus or method which may provide improved cleaning abilities for processing or storing substrates.

### BACKGROUND

Within many fields, and specifically within substrate manufacturing and related industries, the efficient and proper handling, storage and processing of materials such as substrates may be exceedingly important. Since the introduction of the 300-mm wafer semiconductor material, Front Opening Unified Pods, or “FOUPs,” have become the standard storage and transport method of substrates and similar materials. FOUPs have been used to isolate and hold silicon wafers for use in semiconductor production. Semiconductors, fundamental in the design of digital circuitry, microprocessors, and transistors, require these wafers to remain in as close to immaculate condition as storage units allow. Accordingly, FOUPs allow wafers to be transferred between other machines used in the processing and measurement of wafers.

Prior FOUPs generally serve to preserve wafers from the surrounding clean room environment. Yet FOUPs today may be hampered by methods and system designs which may contaminate their contents, chafe wafers, and delay loading and unloading of substrate wafer contents as a result of multifarious construction. In addition, FOUPs may be inherently limited in their design such that bottle necks and other system inefficiencies may hold up processing or other systems. Thus, there may be a need for an invention that more efficiently and accurately accomplishes the desired tasks of FOUPs when working within a larger system construct such as an assembly line or processing line, but also provides for high density storage and buffering capabilities, where at any given moment a FOUP may be called or requested by the line, and as such storage of wafers near processing area may be needed.

Issues with prior substrate storage devices may be exacerbated with construction sizes of typical FOUPs, which may be produced in multiple stages of multiple parts, typically holding a maximum of 25 wafer jobs of 300 mm wafer fibs and device heights of upwards of 330 mm. Recalling that high volume shipments may be imperative, the size of these FOUPs hamper scaling efforts and diminish efficiency by requiring the construction of the storage FOUPs in steps and parts, especially if smaller sized containers may be created to contain the same volume of substrate.

Thus, a substrate storage system, which includes improved design and innovations over the Prior Art FOUPs and associated systems and devices, may be necessary. There may be a need for a storage, buffering and stocking system, method and apparatus which streamlines processes and increases efficiency of creation and ease of replication in the manufacturing process as well as provides a resilient system hierarchy and steps and of which the ability for quick and efficient storage and retrieval as a key part of the method, system or apparatus.

A problem with the above-mentioned system, apparatus or method, may be that even with improved Tec-Cell carriers, as may be the nature with substrate manufacturing, processing and storage, as well as the associated moving machinery, contamination, dust and other containments may still be present. Since cleanliness may be a primary concern within substrate processing, manufacturing and storing, additional cleaning must be used for both the substrates themselves as well as the FOUPs, carriers, compartments and containers. In Prior Art, cleaning of the substrates may be easily accomplished. However, cleaning of the carriers (Tec-Cell Carriers), FOUPs, compartments and containers may be not. In prior art, systems must be shut down while cleaning, which can happen often and will slow down the assembly line or manufacturing processes.

It may be therefore an object of this invention to provide a device which may be used for substrate or wafer containment, transportation, storage and holding in semiconductor manufacturing or like processes, as well as provide a system, method or apparatus to aide in the cleaning of the compartments, carriers and containers for substrates within a system, such that the system downtime may be none to minimal, and wherein the items being cleaned are thoroughly cleaned on demand such that less cleanings are necessitated.

### SUMMARY

Disclosed may be methods, apparatus, and systems that provide one example embodiment, to an improved substrate storage system, method or apparatus with on-demand cleaning abilities.

In one embodiment, a substrate stocker system may be provided that includes a high density storage chamber that comprises a plurality of compartments, each storing one or more high density substrates; one or more robots configured to move one or more compartments of the high density storage chamber for cleaning, and a cleaning module configured to clean the one or more compartments, while the one or more compartments hold corresponding one or more substrates.

In another embodiment, a method of cleaning a substrate stocker system may be provided. The substrate stocker system includes a high density storage chamber that includes one or more compartments, each storing one or more high density substrates. The method includes emptying a compartment of one or more high density substrates by a robot; flooding the compartment with a cleaning solution till a predefined height; draining out the cleaning solution from the compartment; and stocking the cleaned compartment with the one or more high density substrates.

In another embodiment, a method of cleaning a substrate stocker system may be provided. The substrate stocker system includes a high density storage chamber that includes one or more compartments, each storing one or more high density substrates. The method includes emptying a compartment of one or more high density substrates by a robot; rinsing a compartment with a cleaning solution; and transferring the rinsed compartment to an exterior cleaning location for further cleaning, the further cleaning being performed using at least one of: a heater, pressurized air, a sonic vibrator, and an ultrasonic vibrator.

The methods and systems disclosed herein may be implemented in any means for achieving various aspects. Other features may be apparent from the accompanying drawings and from the detailed description that follows.

### BRIEF DESCRIPTION OF THE DRAWINGS

Example embodiments may be illustrated by way of example and may be not limited to the figures of the accompanying drawings, in which, like references indicate similar elements.

FIG. 1A may be a side cutout view of a container that may be being completely filled with a cleaning solution, in accordance with an embodiment of the present invention;

FIG. 1B may be side cutout view of a container that may be being partially filled with a cleaning solution, in accordance with another embodiment of the present invention;

FIG. 1C may be side cutout view of an empty container that may be being flooded with a cleaning solution, in accordance with another embodiment of the present invention;

FIG. 1D may be side cutout view of an empty container that may be being partially flooded with a cleaning solution, in accordance with another embodiment of the present invention;

FIG. 2A may be a top view diagram of a container that may be to be cleaned, in accordance with an embodiment of a present invention;

FIG. 2B may be a top view diagram of a container that may be to be cleaned, in accordance with an embodiment of a present invention;

FIG. 3A may be a top view diagram of a container and cart system that may be to be cleaned, in accordance with an embodiment of a present invention;

FIG. 3B may be a top view diagram of a container and cart system that may be to be cleaned, in accordance with an embodiment of a present invention;

FIG. 4A may be a top view diagram of a container that may be to be cleaned within a stocker, in accordance with an embodiment of a present invention;

FIG. 4B may be a top view diagram of a container that may be to be cleaned within a stocker, in accordance with an embodiment of a present invention;

FIG. 4C may be a top view diagram of a container that may be to be cleaned within a stocker, in accordance with an embodiment of a present invention;

FIG. 5A may be a top view diagram of a container, in a load port, that may be to be cleaned, in accordance with an embodiment of a present invention;

FIG. 5B may be a top view diagram of a container, in a load port, that may be to be cleaned, in accordance with an embodiment of a present invention;

FIG. 6A may be a top view diagram of a container, in a load port, that may be to be cleaned at an exterior location, in accordance with an embodiment of a present invention;

FIG. 6B may be a top view diagram of a container that may be to be cleaned, in a direct transfer to an exterior location, in accordance with an embodiment of a present invention;

FIG. 7A may be a side view of a cleaning system, in accordance with an embodiment of a present invention;

FIG. 7B may be a side view of a cleaning system, in accordance with an embodiment of a present invention;

FIG. 7C may be a side view of a cleaning system, in accordance with an embodiment of a present invention;

FIG. 7D may be a side view of a cleaning system, in accordance with an embodiment of a present invention;

FIG. 8A may be a process diagram of a cleaning system, in accordance with an embodiment of a present invention;

FIG. 8B may be a process diagram of a cleaning system, in accordance with an embodiment of a present invention;

FIG. 9 may be a process diagram of a cleaning system, in accordance with an embodiment of a present invention;

FIG. 10 may be a process diagram of a cleaning system, in accordance with an embodiment of a present invention;

FIG. 11 may be a process diagram of a cleaning system, in accordance with an embodiment of a present invention;

FIG. 12 may be a process diagram of a cleaning system, in accordance with an embodiment of a present invention;

Other features of the present embodiments will be apparent from the accompanying drawings and from the detailed description that follows.

### DETAILED DESCRIPTION

Disclosed may be methods, apparatus, and systems that may provide a storage system, apparatus or method which may provide improved efficiency in readily being able to store and provide substrates to a system such as for processing or use.

In an embodiment, which may be combined with any other embodiment, the present invention may provide for a substrate storage or stocker.

In an embodiment, which may be combined with any other embodiment, the present invention may provide for a substrate storage or stocker including further methods, apparatuses, systems and subsystems and devices mentioned herein at least.

In an embodiment, which may be combined with any other embodiment, the present invention may provide a stocker system, wherein the stocker system includes mechanisms such as openers, robots, etc. Additionally, the stocker may include at least one compartment, to store the high-density substrates. The compartments may be rigidly structured or permanently mounted within the stocker, such that the compartments may be accessed by a robot to store the high-density wafers.

In an embodiment, which may be combined with any other embodiment, the present invention may provide for substrate storage modules such as containers or compartments of a stocker system that may include any type of substrates holders to aid in holding semiconductor substrates, wafers, etc. Examples of the substrate holders include, but are not limited to, TecCell carriers. As well as this, it may be seen that the container may also include an Overhead Transport (OHT) or other transport mechanisms and structures necessary for loading, transport and holding. In some embodiment, it may be noted that the compartments may be moveable, such as on a cart, or OHT or other transport system, where the compartments may be moved to be able to be connected to the cleaning system, cart, etc.

In an embodiment, which may be combined with any other embodiment, the present invention may provide for containers or compartments of which may be flooded completely or partially with a liquid for cleaning the container. Examples of liquid include, but are not limited to, such as solvent mixture, cleaner or cleaning solution, wherein the liquid may be a mixture of chemicals, wherein the chemicals clean, dissolve or otherwise remove contaminants such as dust from manufacturing, processing machinery or other sources. It may be apparent to any person skilled in the art, the example of cleaning solution may include, but are not limited to, such as acetone, methanol, ammonium hydroxide, hydrogen peroxide, hydrofluoric acid as well as water, which may be mixed or used as a rinse.

In an embodiment, which may be combined with any other embodiment, the present invention may provide for the container or compartments that may be of prior art design or propriety design. In some embodiment, the container or compartment may have nozzles, and ports to aid in the entrance and removal of the cleaning solution or vapor, such that cleaning may be most efficient. It may be also noted that there are tube and piping connections to the cleaning system, such as pump and reservoir, as well as filtering system etc.

In an embodiment, which may be combined with any other embodiment, the present invention may provide for substrate storage modules such as containers or compartments of which may be flooded and emptied with cleaning solution in multiple steps such as where a first step includes introducing ammonium hydroxide and hydrogen peroxide, with water wherein the compartment may be flooded at a substantial level. The chemicals are allowed to settle in the container for a few minutes, such as 10 minutes, and wherein the chemicals then are able to dissolve any material such as organic or non-organic materials, such as films, dust, residue etc. as well as usually insoluble materials. Subsequent flooding and baths may include cleaning with solutions such as hydrofluoric acid, and hydrogen peroxide, along with water or deionized water mixtures, and rinses.

In an embodiment, which may be combined with any other embodiment, the present invention may provide that the flooding or baths may include the liquid compartments, which are heated such as to 80-100 degrees centigrade, such that the chemicals dissolution may be most efficient. It may be noted that heaters can be a plurality of types, including but not limited to, air heaters or space heaters or wall heaters or electric heaters. Additionally, these heaters may be integral to the container or compartment, or may be external to the container such as in the cleaner cart or in the stocker system itself, wherein the container or compartment may be heated during flooding, or after flooding such as to aid in evaporation of the chemical-liquid so that the container or compartment may be able to be cleaned and dried for use. This may also be done to aid in the vapor or cleaning solution sublimation as well as drying, evaporation or any other reason and may also be done before or after the cleaning solution may be removed or drained.

In an embodiment, which may be combined with any other embodiment, the present invention may provide that the container or compartment may be filled with a liquid, where the liquid may be vaporized and clean the surfaces of the container that comes into contact with it. In some embodiments, the cleaning solution may include a liquid portion and a vapor portion, but in some embodiments, the cleaning solution may include a vapor portion. The vapor, in any case may then sublimate on the surfaces and clean through known prior art methods, including vaporization, sublimation or other cleaning methods.

In an embodiment, which may be combined with any other embodiment, the present invention may provide that container or compartment may be shaken or vibrated during, before or after the cleaning process, of which may aide in the cleaning of the container and interior. This may include vibration provided by motors, within the compartment or container structure, or from the cleaning station itself, such as vibrational motors on the substrate holders. These vibrations may be of any frequency, of which may include sonic or ultrasonic, which may aide in the loosening of the debris within the container or compartment.

In an embodiment, which may be combined with any other embodiment, the present invention may provide for cleaning the compartment wherein a liquid, vapor or other chemical or cleaner may be provided by a reservoir. The reservoir may include a central reservoir for a given system, or may be a reservoir in the cleaning system itself, such as within the cart. The reservoir may provide the fluid through a pressurized system, or non-pressurized system and may be on demand. There may be quick connectors between the system, and the container or compartment and may be automatically connected when the container or compartment may be moved to the cart to be cleaned, or may be semi-permanently or permanently connected when the container or compartment may be in a storage, stocker, or system.

In an embodiment, which may be combined with any other embodiment, the present invention may provide that the fluid, vapor or chemicals may be reused, filtered, purified and recycled, as many times as needed. In addition, when the fluid, vapor may be drained or removed from the container or compartment after cleaning, it may be processed such as through a filter, or may otherwise be purified, cleaned or processed internally or externally to the system, or be sent out to another system, or elsewhere to be cleaned or purified.

In an embodiment, which may be combined with any other embodiment, the present invention may provide that the fluid or vapor may be provided in parts or may be may be mixed on demand or provided in separate constituent parts, such that a given mixture can be provided for a given step, or may be mixed on demand such as particular mixture for a given step.

In an embodiment, which may be combined with any other embodiment, the present invention may provide sensors or other abilities such as that within the container or compartment, or in some embodiments externally to the container or compartment such that the system may provide optimal temperature, quantities of liquid or vapor, time for cleaning, steps, or repetitive steps, such as double cleaning. The sensors may include temperature sensors, liquid sensors, pressure sensors, optical sensors, etc. that may include an ability to sense cleanliness.

In an embodiment, which may be combined with any other embodiment, the present invention may provide for containers or compartments that are liquid tight such that the atmosphere within the compartment or container can be completely isolated from the exterior environment up to a rated pressure, such that liquid or vapor or contaminants do not escape. The containers or compartments may be such that it may have a side door, a bottom door, or a top door, which may be opened, such as in normal use to remove substrates, TecCells, or other objects or may be sealed to hold the cleaning solution and to isolate the interior of the compartment from the exterior. It may be noted that these operably openable doors or sides may then be sealed such as through friction, seals, or other types of seals such that liquid and vapor may be held within during the cleaning process.

In an embodiment, which may be combined with any other embodiment, the present invention may provide one or more robots for transfer of containers and substrates held within the containers in the stocker system. Herein, the robot may include one or more hardware or machines, known in the prior art, such as it may be capable of carrying a series of actions and may be not limited thereto. It may be noted that the robots may be any types of robots, but may include Overhead mounted robots, arm mounted robots, robot with effectors, and conveyors. In an embodiment, a robot may remove a container for cleaning, wherein the cleaning may be done at an exterior site or directly adjacent to the stocker, such as to reduce contamination to the other containers, and other parts of the stocker. In another instance, the compartment or container may be removed such as by a cart, or OHT or other transport system, and may be moved to a cleaner station or area, where the compartment may be flooded and cleaned, and thereafter it may be moved back.

In an embodiment, which may be combined with any other embodiment, the present invention may provide for a dock cart assembly that may include multiple containers, and a robot to move the containers within the dock cart assembly. The dock cart may be being able to be directly mounted to the container or compartment on the stocker, and also within the cart, such that the cart may transfer the container or compartments. The dock cart may remove a container for cleaning, wherein the cleaning may be done at an exterior site or directly adjacent to the stocker such as on the dock cart assembly, wherein the dock cart includes the reservoirs, or sources for the cleaning solution as well as abilities for heating or sonic treatment as needed.

In an embodiment, which may be combined with any other embodiment, the present invention may provide for a stocker system that may include a cleaning station where a container may be moved by a robot, such that the cleaning steps may be undertaken and as well as, it may be isolated from the rest of the stocker to reduce contamination.

In an embodiment, which may be combined with any other embodiment, the present invention may provide that one or more containers may be cleaned at the same time within the stocker. Further, cleaning may be done in different steps at different locations. For instance, a basic cleaning such as rinsing with cleaning solution, may be performed within the stocker. Later, the container or compartment, may be transferred to a dock cart or other location for deep cleaning, which may include heating and providing vibration. It may also be noted, that the structures, piping and necessary heaters and vibrators are integral to the container or compartment or stocker and may also be present in the dock cart or other exterior locations.

In an embodiment, which may be combined with any other embodiment, the present invention may provide that the containers may be removed from the stocker by an internal robot for cleaning, whereas the container may be moved to a loading dock or port, such that to be removed from the stocker. Thereafter, the container or compartment may be moved by a robot or OHT, to an externally held position such as a cleaning location or dock cart so that the container or compartment may be cleaned at that position, and thereafter it may be moved back. This may be done to limit the internal contamination by the stocker and ease of connections for cleaning need. The robot may be different than the substrate opener robot, but also may be the same to reduce complexity and space limitations. It may also be noted that the container location in the stocker may be left empty until the compartment or container may be cleaned, or may be refilled by another container or compartment brought through the load port, or another load port or location.

In an embodiment, which may be combined with any other embodiment, the present invention may provide that a container may be moved to a load port from where it can be transported to a cart for cleaning. It may be seen, that the load port may also have an external dock cart that may act as a buffer with an empty clean compartment or container, such that the dock cart may pull a dirty container from the load port for cleaning, and put in a previously cleaned container therein, to provide low downtime.

It may be noted that one or more loading dock or port may be incorporated in the structure which may be positioned in one or more locations around the stocker system. The loading port may be a separate entity to facilitate the transfer of containers to external locations, such as dock cart, for cleaning purpose. These one or more loading ports may be coupled to the stocker system through various connector mediums and may be not limited thereto. Once the loading ports are connected to stocker, they may receive the dirty containers or compartments from the stocker and move them to the dock cart where cleaning of these containers or compartments can be performed so as to reduce the contamination to outside only. These loading ports may be permanently connected to the stocker system or may be connected and disconnected on frequent basis, whenever the exchange of containers or compartments may be required.

In an embodiment, which may be combined with any other embodiment, the present invention loading ports may be placed at any of the locations around the stocker. This may include, but are not limited to, internal to the stocker or external to the stocker, including top, bottom or sides-ways of the stocker system. They may also be placed on one or more locations simultaneously to facilitate the fast processing of the containers or compartments. Further, they may be temporarily or permanently connected to the dock cart externally, to fetch the previously cleaned containers or compartments and move them back in empty spaces of the stocker system.

In an embodiment, which may be combined with any other embodiment, the present invention loading ports may include one or more robots to assist the exchange process of the containers or compartments. The robot may be integral to the loading port or may be placed at some nearby exterior location. This robot may be same as disclosed in the stocker system or may vary in structure, but may be not limited thereto. Further, the loading ports may execute some of the preliminary cleaning steps within itself, with the help of the robots. These preliminary cleaning steps may include, but may be not limited to, pouring of cleaning solutions in the containers or compartments, aiding in bubble formation through a vibratory motion or preliminary heating of cleaning solutions etc.

In an embodiment, which may be combined with any other embodiment, the present invention may provide that a single container or compartment may be cleaned at a time, and in other instances, multiple compartments can be cleaned at a time. Also, there may be an ability to provide for different steps to different compartments being cleaned. This may include, for example, a compartment or container may be moved onto a cart, where multiple containers or compartments have been taken offline from a stocker and moved onto a cart, and wherein once the container or compartment may be moved onto a cart, the flooding and cleaning process may be started. However, since the cart houses multiple container sand compartments at one time, and wherein the flooding and cleaning are done simultaneously with multiple compartments and containers, then there may be a compartment or container whose cleaning may be finished, when the newest compartment may be unloaded, such that the cart or transport system may then instantly replace the dirty compartment or container empty slot on the stocker with a clean container or compartment immediately, thereby reducing downtime in the stocker system.

In an embodiment, which may be combined with any other embodiment, the present invention may provide that the cleaning may be done with substrates within the container or compartments. In other embodiments, the cleaning may be done with the substrate holders or other mechanisms still within the compartments and in some other embodiments, the cleaning and loading may be done with the compartments or containers being empty.

In an embodiment, which may be combined with any other embodiment, the present invention may provide that the containers are flooded to different levels. In one embodiment, the container or compartment may be filled completely, wherein little to no unflooded volume exists in the container or compartment. In other embodiments, the container or compartment are only filled to submerge certain mechanisms or interior in the compartment or container. In other embodiments, the containers or compartment are filled to a particular height for maximum efficiency.

In an embodiment, which may be combined with any other embodiment, the present invention may provide for pressurized liquid or vapor, wherein the reservoir may be pressurized by a pump or by known methods, wherein the vapor or liquid may be pressurized between the reservoir and outlets. Further, the present invention may provide for pressurized liquid or vapor wherein the vapor or liquid may be pressurized and sprayed into the compartment, wherein nozzles are directly or indirectly able to create a spray pattern such that the interior may be covered or sprayed entirely, or the coverage selection may be at least efficiently or purposefully, such that in the area of known high contamination receive coverage. The spray of liquid or vapor may aid in the sanitation and cleaning of the interior of the compartment. Thus, the pressurized spray may mechanically or forcefully clean the interior of the compartment or container.

In an embodiment, which may be combined with any other embodiment, the present invention may provide for forced air, such as heated forced air or gas into the compartment wherein the forced air or gas may aide in cleaning, or drying the interior of the compartment. This may be noted that the air may also provide for evaporation of the interior chemicals, and residue such that the interior may be sufficiently or completely cleaned, and no residue or contaminants are left after the cleaning process may be completed. This may be noted that the air may be any gas. The gas may be nitrogen or other inert or active gases that may aid in the cleaning, drying or cleanliness of the interior.

In an embodiment, which may be combined with any other embodiment, the present invention may provide a cleaning process that may be operable to be controlled by computer operation, such as automatic operation, or may be humanly controlled, such as by an operator. Also, individual steps may be carried out automatically based on time, or may be automated through control such as through sensors. As well as this, at any time, an operator may control the process, as well as be able to provide needs, such as the liquid, vapor, etc. through manual interaction.

In an embodiment, which may be combined with any other embodiment, the present invention may provide a cleaner system, such as the cart or compartment, that may interact with a larger system, such as in integration with other system, where the cleaner maybe be integrated into the assembly line, for optimal use. This may be such that the lifecycle, and the cleaning cycles of each compartment or container may be tracked or via sensors, such that when a need for cleaning of a compartment or container may be necessitated, the system may choose an optimal path, time and cleaning regime to be enacted, such that the assembly line, stocker, or otherwise may provide the least downtime. For instance, if the system knows that a compartment in a stocker needs to be cleaned every 90 days, the system may then transport the substrates being stored in the stocker compartment to another compartment when the robot arm has downtime, such that the robot arm and other stockers and compartments are not affected, and such that the stocker compartment to be cleaned may be empty at the time of cleaning.

In an embodiment, which may be combined with any other embodiment, the present invention may provide that these compartments and container may be cleaned in an efficient manner. This may be such that the compartments or containers may be cleaned while within the stocker, such as if the containers or compartments are permanently mounted or integral to the stocker. In other embodiments, the compartments or containers may be such that they may be removed or moved from the stocker to be cleaned, and then replaced, such as by a cleaning cart. It may be noted that the cart may replace the compartment or container to be cleaned immediately by another previously cleaned compartment or container, or by the same compartment or container after cleaning.

In an embodiment, which may be combined with any other embodiment, the present invention may provide a proprietary or known cleaning solution, of which may be heated to clean the container or compartment. The cleaning solution may be used to flood the container or compartment substantially, fully or partially, such that the solution may clean debris, residues and any contamination in the compartment or container. Additionally, there may be other cleaning aides such as exterior or internal heat and vibration such as sonic or ultrasonic vibration. Additionally, the cleaning may be provided, instead of just flooding, or instead of flooding at all, by nozzles where a vapor, such as a vapor of the cleaning solution may enter the compartment or container, wherein the compartment or container may then be cleaned. Any of the steps may be repeated until the compartment may be cleaned. The cleaning solution, heat, etc. may be sourced within the cart, or within integral reservoirs or sources. As well as, they may be sourced through piping and hosing integral to the stocker or exterior systems, from at least one central source.

In an embodiment, which may be combined with any other embodiment, the present invention may provide for a cleaning cart, wherein the compartments or containers are cleaned on the cart. The cart may include then multiple containers or compartments at one time. It may be provided that the cleaning may be done in stages, wherein each compartment or container, which was added to the cart at a different time, may be in different stages of cleaning. For instance, the first compartment added to the cart may undergo a rinse first, wherein by the time the compartment or container may be done rinsing, a second container or compartment may have been added to the cart, such that the first cart by that time may be onto a second heated rinsing phase. Thereafter, a 3^{rd} cart may be added or grabbed from the stocker, and it may undergo the first rinsing phase, while the first cart may be finishing the heating rinse phase, and the second cart may be finishing the rinse phase. This may continue as a pattern for as many containers or compartment the cart carries, and may be such that compartments or containers may be waiting after being cleaned, such that they may be added back to the stocker on demand basis. This may also aid in division of resources, such as the total liquid available for a given reservoir, and may directly transfer fluid between the compartments or containers, or may then be able to provide the fastest cleaning rather than wait for batches.

In an embodiment, which may be combined with any other embodiment, the substrate stocker system may comprise one or more high density storage chamber that may comprise a plurality of compartments, each storing one or more high density carriers and substrates wherein there may then be one or more robots configured to move one or more compartments of the high density storage chamber and wherein then the one or more cleaning modules may be configured to clean the one or more compartments and wherein one or more transport mechanism for moving the one or more compartments to or from the one or more cleaning modules for cleaning and wherein then the transport mechanism may be one or more robots.

In some embodiments, for instance, the opener station and transport mechanism may be able to open or close the high density container, such that substrates and carriers are able to be moved to or from the container, wherein then the container may be emptied prior to cleaning or filled after cleaning.

In an embodiment, which may be combined with any other embodiment the substrate stocker includes the cleaning module as interior or exterior to the stocker system.

In an embodiment, which may be combined with any other embodiment the cleaning module may perform cleaning of one or more compartments using at least one of: a cleaning solution, an external heater, pressurized air, an internal heater, a sonic vibrator, and an ultrasonic vibrator.

In an embodiment, which may be combined with any other embodiment the cleaning solution may be selected from at least one of: acetone, methanol, ammonium hydroxide, hydrogen peroxide, hydrofluoric acid and water.

In an embodiment, which may be combined with any other embodiment the cleaning module may includes a dock cart, wherein the compartment may be able to be moved to the dock cart, the dock cart cleans the compartment, the compartment may be able to be moved back to the high density storage chamber, and the dock cart includes at least one of: a reservoir of a cleaning solution pressurized air, heater, and sonic or ultrasonic vibrator.

In an embodiment, which may be combined with any other embodiment wherein the cleaning module may comprise one or more sensors for tracking cleaning of the one or more compartments, wherein the one or more sensors are selected from at least one of: a temperature sensor, a liquid sensor, a pressure sensor, and an optical sensor; and a controller communicatively coupled to the one or more sensors for automating a cleaning regime of the one or more compartments, wherein the controller may be configured to automatically set at least one of: an optimal temperature, a quantity of cleaning solution, and a cleaning time. This may be optionally connected to a network to be controlled automatically or manually by a computer, system or user.

In an embodiment, which may be combined with any other embodiment each compartment has a door that may be operable to be sealed to hold a cleaning solution and opened such that the carriers and substrates can be accessed.

In an embodiment, which may be combined with any other embodiment the external and internal heaters are configured to heat a compartment to a temperature ranging from 80 to 100 degree centigrade to aid in the vapor cleaning and drying of the compartment.

In an embodiment, which may be combined with any other embodiment the cleaning module may include one or more nozzles for spraying the cleaning solution into a compartment.

In an embodiment, which may be combined with any other embodiment the cleaning module comprises a filtering module for filtering the cleaning solution that may be drained out of a compartment after cleaning to be reused, recycled or disposed.

In an embodiment, which may be combined with any other embodiment a method of cleaning a substrate stocker system, may include emptying one or more compartment of one or more high density substrates by one or more robots, flooding the compartment with a cleaning solution till a predefined height, soaking the compartment with a cleaning solution for a predefined time period, draining out the cleaning solution from the compartment; and stocking the cleaned compartment with the one or more high density substrates.

Additionally in an embodiment, which may be combined with any other embodiment, the method may include transferring an uncleaned compartment from the high density storage chamber to a dock cart; and transferring a previously cleaned container from the dock cart to the high density storage container.

In an embodiment, which may be combined with any other embodiment, the method then may include wherein after emptying the compartment, one or more compartments are transferred from the high density storage chamber to a dock cart, wherein the flooding, soaking and draining are performed at and by the cart, and additionally using one or more of a cleaning solution, heater, and ultrasonic vibrator; and transferring back the one or more cleaned compartment in the high density storage chamber.

In an embodiment, which may be combined with any other embodiment, the dock cart may be able to hold more than one compartment, wherein the cart can facilitate each compartment cleaning process separately such that a previously cleaned compartment can be transferring back to the high density storage chamber on receipt of an uncleaned container.

In an embodiment, which may be combined with any other embodiment, it may be noted that it may be possible transferring an uncleaned compartment from the high density storage chamber to a load port, transferring the compartment from the load port to the exterior cleaning location for cleaning; and refilling the high density storage chamber container location with another cleaned compartment.

It may be noted that the other cleaned compartment may be from the load port and exterior cleaning location, or such as wherein the other cleaned compartment may be from one of: another storage location, an OHT, an opener station, a loading station, another cleaning location.

In other embodiments, the cleaning of the compartment may be facilitated in place in the high density storage chamber. Wherein the cleaning of the compartment may be facilitated interior to the stocking system or may be facilitated interior to the stocking system.

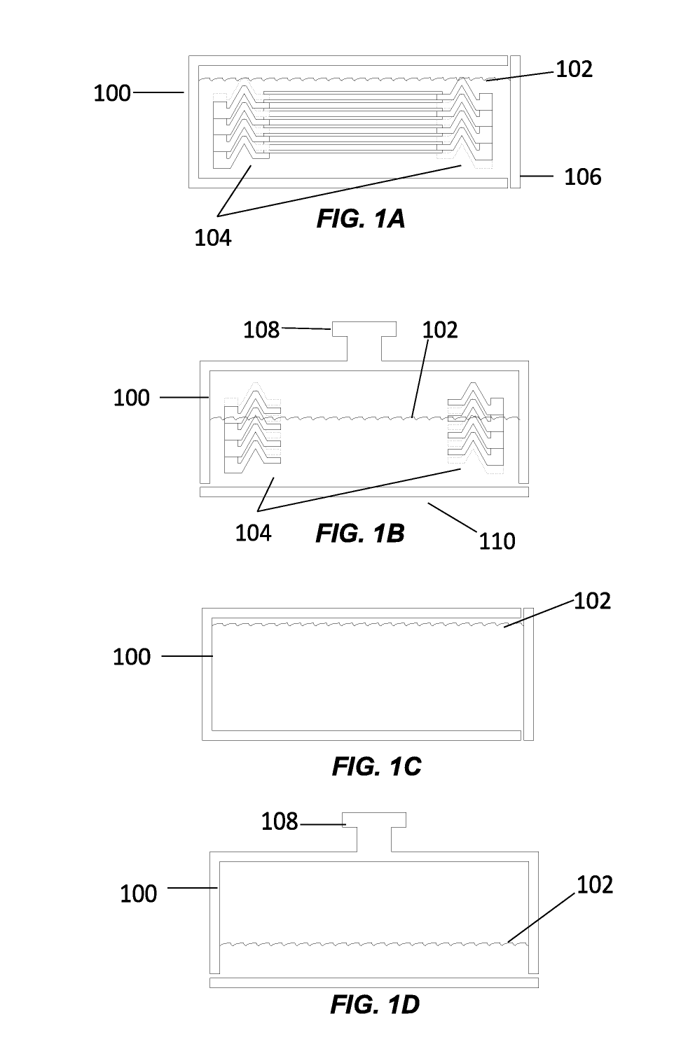

FIG. 1A depicts a side cutout view of a container 100, in accordance with an embodiment of a present invention. The container 100, hereinafter also referred to as compartment 100 may be a container of a stocker system that may include substrates holders 104 to aid in holding semiconductor substrates, wafers, etc. In an embodiment, the container 100 may be completely filled with a cleaning solution 102 for cleaning the container 100. It may be noted that the container 100 may also include a side door 106, which may be sealed to hold the cleaning solution and may also be used to isolate the interior of the compartment 100 from the exterior. This door 106 may be operable to remove substrates in normal operation. In some limited embodiments, there may be substrates held at the time of cleaning as well. It may be noted that the container or compartment in any embodiment may have nozzles, and ports (not shown) to aid in the entrance and removal of the cleaning solution or vapor.

FIG. 1B depicts a side cutout view of a container 100, in accordance with an embodiment of a present invention. The container 100 may be partially filled with a cleaning solution 102 and wherein the container or compartment may include substrates holders 104 as TecCell carriers. As well as this, it may be seen that the container 100 may also include an Overhead Transport vehicle (OHT) 108 or other transport mechanisms and structures necessary for loading, transport and holding. It may be noted that the container 100 may also include a bottom door 110, which may be sealed to hold the cleaning solution 102, and may also be to isolate the interior of the container 100 from the exterior. The bottom door 110 may be operable to remove substrates in normal operation.

It may be appreciated that the various systems, methods, and apparatus disclosed herein may be embodied in a machine-readable medium and/or a machine accessible medium compatible with a data processing system (e.g., a computer system) and of which may be in any form including transitory, non-transitory or persistent data systems, as well as may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

FIG. 1C depicts a side cutout view of an empty container 100, in accordance with an embodiment of a present invention. The container 100 may be fully filled with a cleaning solution 102 and may be empty of any substrates or substrates holders such as TecCell holders.

FIG. 1D depicts a side cutout view of an empty container 100, in accordance with an embodiment of a present invention. The container 100 may be shown to be partially filled with a cleaning solution 102 and shown to be empty of any substrates or substrates holders such as TecCell holders.

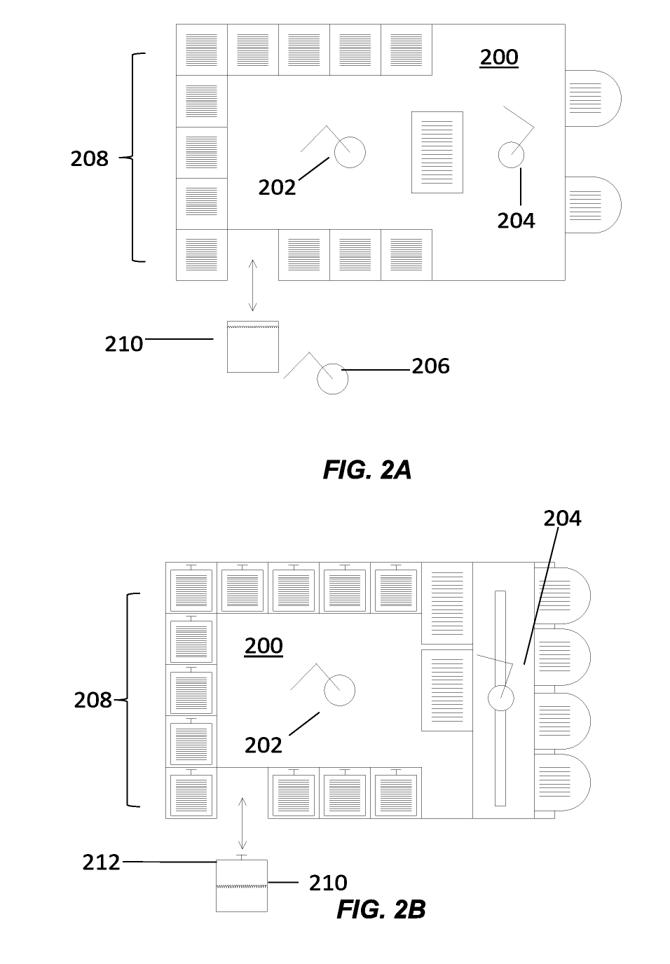

FIG. 2A depicts a top view diagram of a stocker system 200, in accordance with an embodiment of a present invention. The stocker 200 includes one or more high density movable containers 208, and one or more robots 202, 204, and 206 for transfer of containers 208 and substrates held within the containers 208 in the stocker system 200. In an embodiment, a robot 206 may remove a container 210 for cleaning, wherein the cleaning may be done at an exterior site or directly adjacent to the stocker 210, such as to reduce contamination to the other containers 208, and other parts of the stocker 200. It may be noted that the compartment or container 210 being cleaned may be filled fully with a cleaning solution.

FIG. 2B depicts a top view diagram of a stocker system 200, in accordance with an embodiment of a present invention. The stocker 200 includes high density movable containers 208, and one or more robots 202 and 204 for moving the containers 208, and substrates held within the containers 208, in the stocker system 200. A OHT 212 may remove the container or compartment 210 for cleaning, wherein the cleaning may be done at an exterior site or directly adjacent to the stocker 200, such as to reduce contamination to the other containers 208, and other parts of the stocker 200. It may be noted the compartment 210 being cleaned may be filled partially with a cleaning solution.

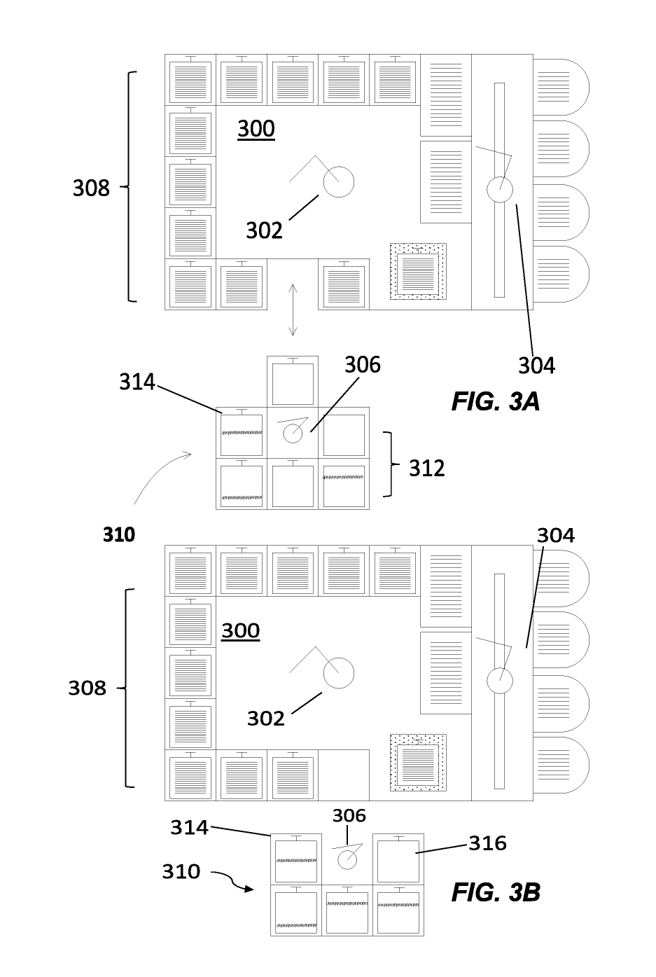

FIG. 3A depicts a top view diagram of a stocker system 300, in accordance with an embodiment of a present invention. The stocker system 300 includes one or more high density movable containers 308, and one or more robots 302, 304, and 306 for moving the containers 308, and substrates held within the containers 308, in the stocker system 300. A dock cart 310 may be illustrated, that docs multiple containers 314, and wherein the cart 310 includes a robot 306 to move the containers 314 within, and may be cleaning the containers or compartments docked at different steps simultaneously.

In an embodiment, the dock cart 310 may remove a container for cleaning, wherein the cleaning may be done at an exterior site or directly adjacent to the stocker 300 such as on the dock cart 310, wherein the dock cart 310 includes the reservoirs, or sources 312 for the cleaning solution as well as abilities for heating or sonic treatment as needed.

The dock cart 310 may be being able to be directly mounted to the container or compartment on the stocker 300, and also within the cart 310, such that the cart 310 may transfer the container or compartments.

FIG. 3B depicts a top view diagram of a stocker system 300, in accordance with an embodiment of a present invention. The stocker system 300 includes high density removable containers 308, and one or more robots 302, 304, and 306. A dock cart 310 may remove the container 314 for cleaning, wherein the cleaning may be done at an exterior site or directly adjacent to the stocker 300, such as on the dock cart 310, wherein the dock cart 310 includes the reservoirs, or sources for the cleaning solution as well as abilities for heating or sonic treatment as needed. The dock cart 310 also shows the robot 306 on the dock cart 310, being able to directly mount to the container or compartment on the stocker 300, and within the cart 310, such that the robot 306 may transfer the container or compartments.

It may be noted that the dock cart 310 has docked multiple containers and compartments 314 wherein the dock cart 310 includes a robot 306 to move the containers and compartments, and may be cleaning the containers or compartments 314 docked at different steps simultaneously including a drying step for drying the containers or compartments 316. Further, it may be noted that the container or compartment 316 may have already been processed through various cleaning stages and may be completely dried and may be ready for reuse. This dried container or compartment 316, then may be transported to the stocker system immediately, to replace the dirty containers or compartments 308 in the stocker 300, so as to provide low downtime.

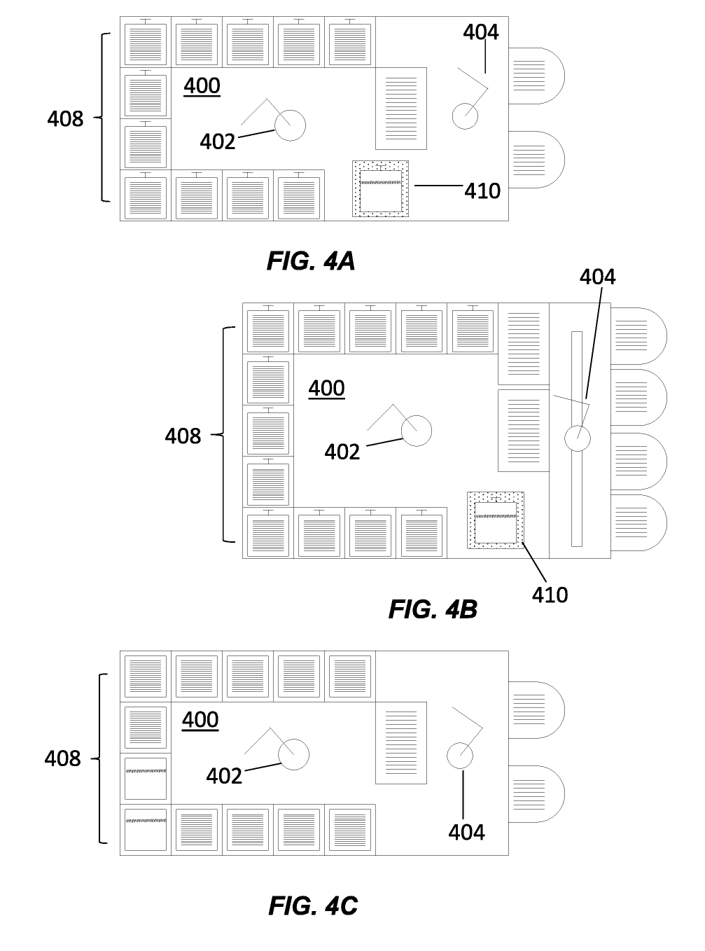

FIG. 4A depicts a top view diagram of a stocker system 400 that may be to be cleaned, in accordance with an embodiment of a present invention. The stocker system 400 includes high density removable containers 408 and one or more robots 402 and 404 for moving the containers 408 within the stocker system 400. The stocker system 400 may include a cleaning station 410 where a container 408 may be moved by a robot 402, such that the cleaning steps may be undertaken and as well as, it may be isolated from the rest of the stocker 400 to reduce contamination.

FIG. 4B depicts a top view diagram of a stocker system 400, in accordance with an embodiment of a present invention. The stocker system 400 includes high density removable containers 408, and one or more robots for moving the containers 408 within. There may be a cleaning station 410 within the stocker 400, where a container 408 may be moved by a loading robot 402, such that the cleaning steps may be undertaken and as well as, it may be isolated from the rest of the stocker 400 to reduce contamination.

FIG. 4C depicts a top view diagram of a stocker system 400, in accordance with an embodiment of a present invention. The stocker system 400 includes high density movable containers 408 and one or more robots 402 and 404 for moving the containers 408 within. In an embodiment, one or more containers 408 may be cleaned at the same time within the stocker 400. Further, cleaning may be done in different steps at different locations. For instance, a basic cleaning such as rinsing with cleaning solution, may be performed within the stocker 400. Later, the container or compartment, may be transferred to a dock cart or other location for deep cleaning, which may include heating and providing vibration. It may also be noted, that the structures, piping and necessary heaters and vibrators are integral to the container or compartment or stocker or may also be present in the dock cart or other exterior locations.

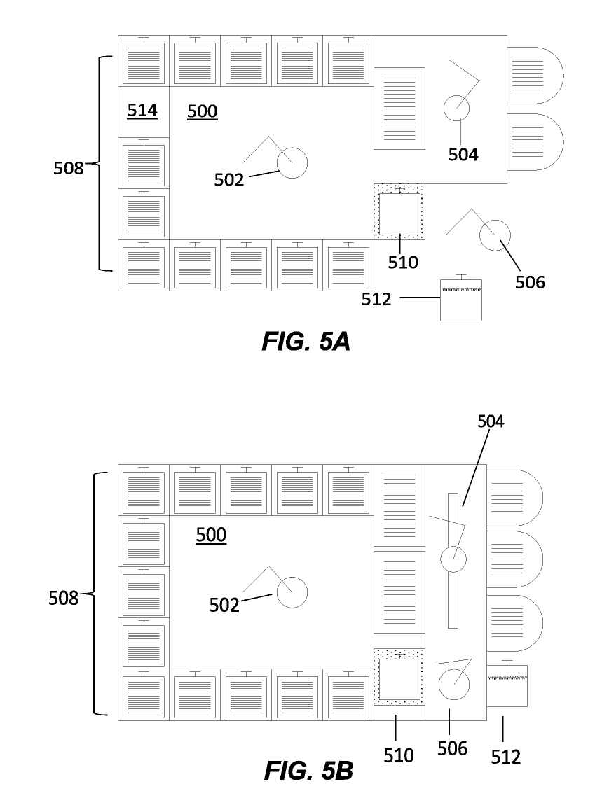

FIG. 5A depicts a top view diagram of a stocker system 500 that includes a container in a load port in accordance with an embodiment of a present invention. The stocker 500 includes high density movable containers 508 and one or more robots 502, 504, and 506 for moving the containers 508 within. In an embodiment, the containers 508 may be removed from the stocker 500 by an internal robot 502 for cleaning, whereas the container 508 may be moved to a loading dock or port 510, such that to be removed from the stocker. Thus, it reduces the contamination to the exterior of the stocker 500, and thereafter, it may be moved by a robot or OHT 506, to a cleaning location 512 or dock cart. It may also be noted that the container location 514 in the stocker 500 may be left empty until the compartment or container may be cleaned, or may be refilled by another container or compartment brought through the load port 510, or another load port or location.

FIG. 5B depicts a top view diagram of a stocker system 500 that includes a container in a load port, in accordance with an embodiment of a present invention. The stocker 500 includes high density movable containers 508 and one or more robots 502, 504, and 506 for moving the containers 508 within. The containers 508 may then be removed from the stocker 500 by an internal robot 502 for cleaning, whereas the container or compartment may be moved to a loading dock or port 510. Thereafter, the container or compartment may be moved to an externally held position 512 such that the container or compartment may be cleaned at that position. This may be done to limit the internal contamination by the stocker 500 and ease of connections for cleaning need. The robot 506 may be different than the substrate opener robot 502 as pictured, but also may be the same to reduce complexity and space limitations.

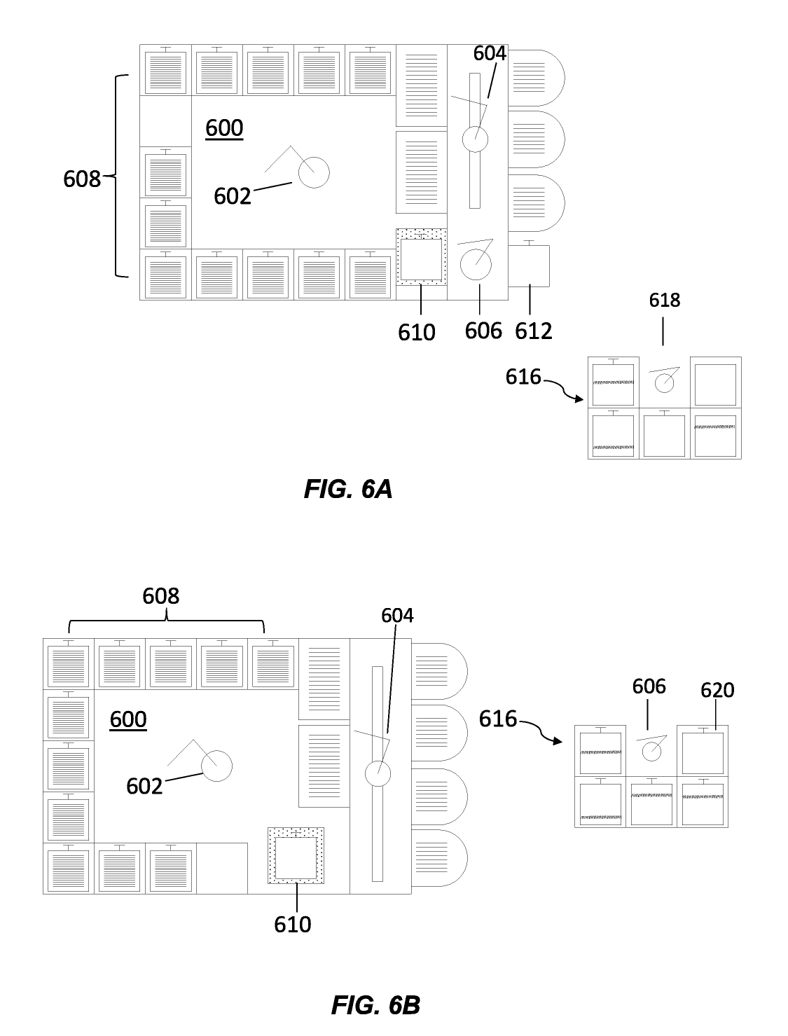

FIG. 6A depicts a top view diagram of a stocker system 600 that includes a container in a load port in accordance with an embodiment of a present invention. The stocker system 600 includes high density containers 608, and one or more robots 602, 604, 606, and 618 for moving the container within. The compartments or containers 608 may then be removed from the stocker 600 by an internal robot 602 for cleaning. Further, a container 608 may be moved to a load port 610, from where it can be transported to a cart 612 for cleaning. It may be seen, that the load port 610 may also have an external dock cart 616 that may act as a buffer with an empty clean compartment or container, such that the dock cart 616 may pull a dirty container 608 from the load port 610 for cleaning, and put in a clean container therein.

FIG. 6B depicts a top view diagram of a stocker system 600 that includes a container for direct transfer to an exterior location for cleaning, in accordance with an embodiment of the present invention. The stocker system 600 includes high density containers 608 and one or more robots 602, 604, and 606 for moving the containers 608. The containers 608 may then be removed from the stocker 600 by an internal robot 602 for cleaning. Thereafter, the compartment or container 608 may be moved to a load port 610, wherein the container or compartment 608 may be moved directly to a dock cart or an external location 616 for cleaning where drying of the containers or compartments 620 may also be performed.

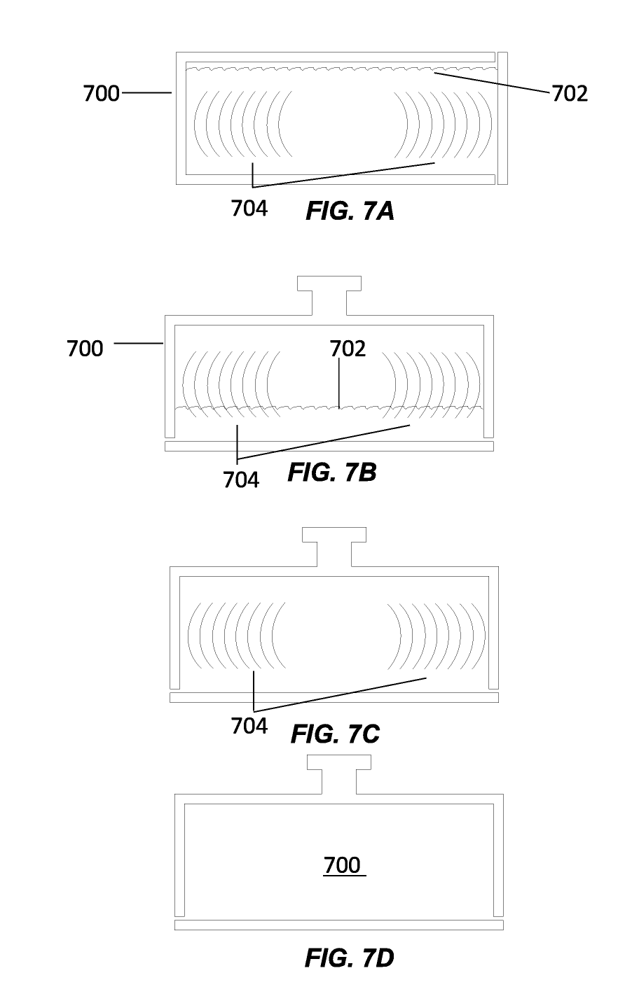

FIG. 7A depicts a side view of cleaning a container 700 of a stocker system, in accordance with an embodiment of the present invention. A cleaning solution 702 or a vapor cleaning solution 702 fully submerging or covering the interior of the container or compartment 700 along with ultrasonic vibration 704, may aide in the cleaning of the container 700. It may be noted herein, that there also may be heaters that heat the cleaning solution or vapor, or the interior space.

FIG. 7B depicts a side view of cleaning a container 700 of a stocker system, in accordance with an embodiment of the present invention. A cleaning solution 702 or a vapor cleaning solution partially submerging or covering the interior of the container or compartment 700 along with ultrasonic vibration 704, which may aide in the cleaning. It may be noted herein, that there also may be heaters that heat the cleaning solution or vapor, or the interior space.

FIG. 7C depicts a side view of cleaning a container 700 of a stocker system, in accordance with an embodiment of the present invention. Herein, solely the ultrasonic vibration 704 may aide in the cleaning. It may be noted that there also may be heaters that heat the cleaning solution or vapor, or the interior space.

FIG. 7D depicts a side view of cleaning a container 700 of a stocker system, in accordance with an embodiment of the present invention. Herein, heaters may be present for heating the cleaning-solution or vapor, or the interior space of containers or compartments 700, solely to evaporate previous solution, or simply to bake the interior contaminants, to be cleaned.

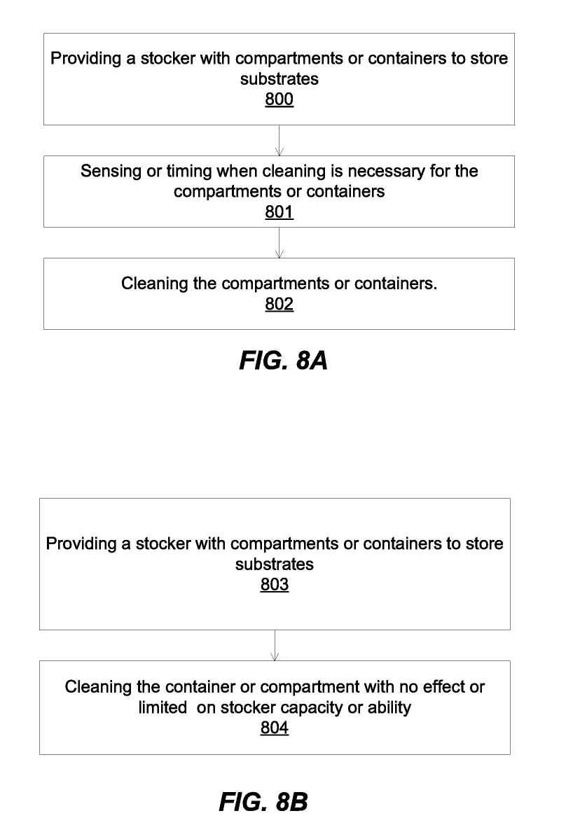

FIG. 8A describes a process diagram of cleaning of a stocker system, in accordance with an embodiment of the present invention. Step 800 includes providing a stocker system with high density compartments or containers to store substrates. Step 801 includes sensing or timing, to determine when cleaning may be necessary for the compartments or containers, and step 802 includes performing cleaning of the compartments or containers.

FIG. 8B describes a process diagram of cleaning of a stocker system, in an embodiment of the present invention. Step 803 includes provides a stocker with compartments or containers to store substrates. Step 804 includes cleaning the container or compartment with no effect or has limited effect on stocker capacity or ability.

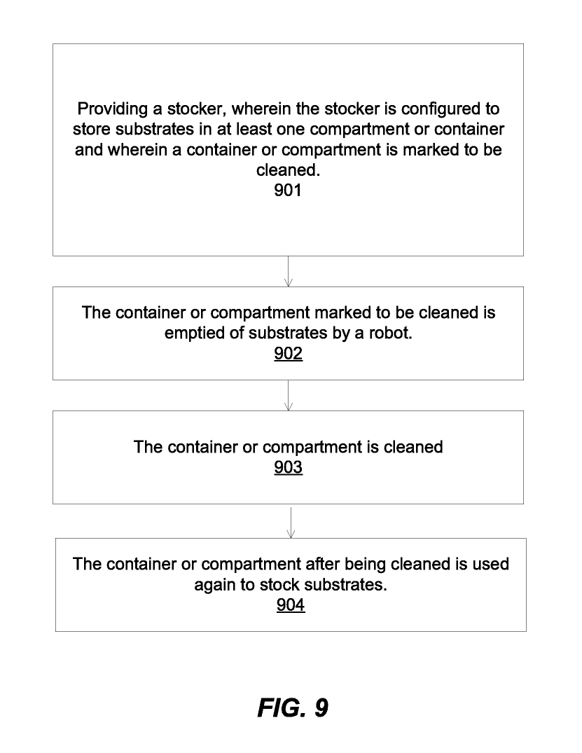

FIG. 9 describes a process diagram of cleaning of a stocker system, in an embodiment of the present invention. Step 901 includes providing a stocker which may be configured to store substrates in at least one compartment or container, and wherein a container or compartment may be marked to be cleaned. Step 902 includes emptying the container of its substrates by a robot that may be to be marked to be cleaned. Step 903 includes cleaning the container or compartment, and step 904 includes using the container or compartment to stock substrates after it may be being cleaned.

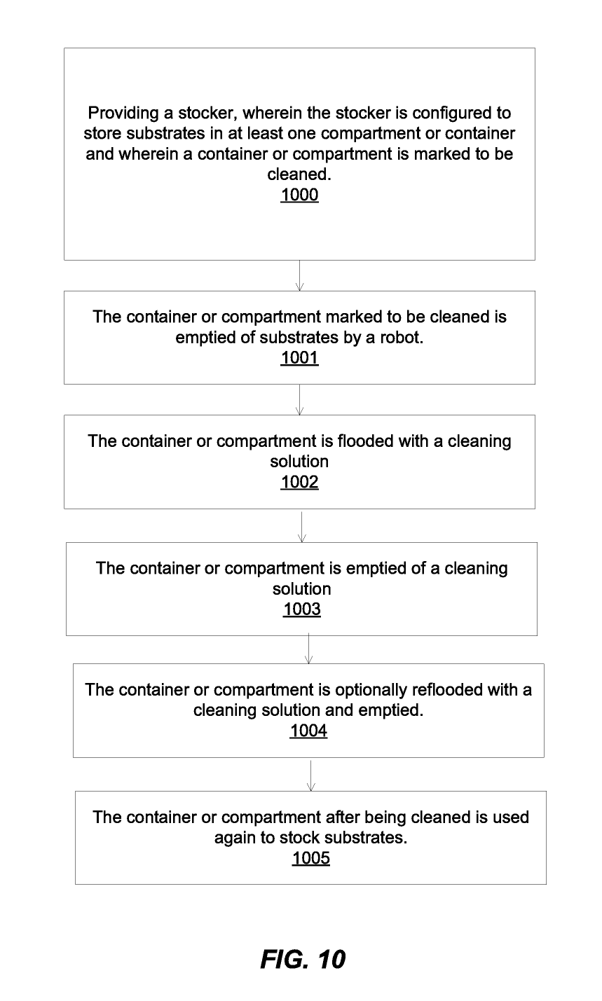

FIG. 10 describes a process diagram of cleaning of a stocker system, in an embodiment of the present invention cleaning system. At step 1000, a stocker may be provided that may be configured to store substrates in at least one compartment or container. Further, a container or compartment may be marked to be cleaned. At step 1001, the container or compartment marked to be cleaned may be emptied of substrates by a robot. At step 1002, the container or compartment may be flooded with a cleaning solution and at step 1003 the container or compartment may be emptied of a cleaning solution. Further, the container or compartment may be optionally re-flooded with a cleaning solution and emptied at step 1004. At step 1005, the container or compartment may be used again to stock substrates after being cleaned.

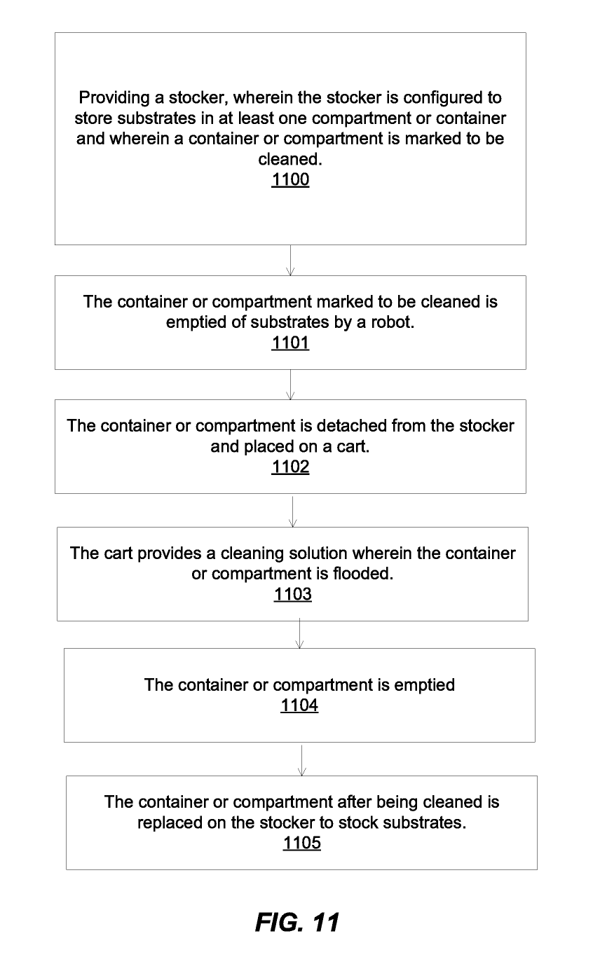

FIG. 11 describes a process diagram of cleaning of a stocker system, in an embodiment of the present invention. At step 1100, a stocker may be provided that may be configured to store substrates in at least one compartment or container. Further, a container or compartment in the stocker may be marked to be cleaned. At step 1101, the container or compartment marked to be cleaned may be emptied of substrates by a robot and at step 1102, the container or compartment may be detached from the stocker and placed on a dock cart. At step 1103, the cart provides a cleaning solution for flooding the container or compartment. At step 1104, the container or compartment may be emptied of a cleaning solution. At step 1105, the container or compartment may be replaced on the stocker to stock substrates after being cleaned.

It may be noted that in this embodiment, along with any other embodiment, the container or compartment may be heated substantially to any degree, such as 200 degrees Fahrenheit to aid in the cleaning and effectiveness of the cleaning solution. This may also be done to aid in the vapor or cleaning solution sublimation as well as drying, evaporation or any other reason and may also be done before or after the cleaning solution may be removed or drained. Further, it may be noted that the heaters can be a plurality of types, including but not limited to, air heaters, space heaters, wall heaters, electric heaters, heaters for the inside of the chambers, heaters heating the walls/interiors of the compartments, wherein the heaters are being placed in the stocker chamber or inside wall of the containers or in the interior of the compartments, as well as, may also be placed to some other exterior locations.

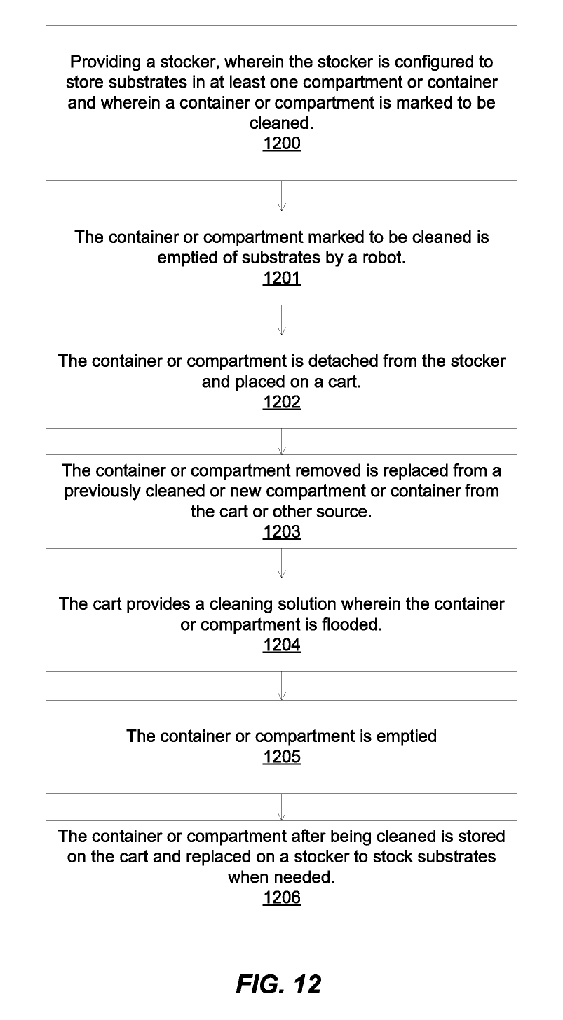

FIG. 12 describes a process diagram of cleaning of a stocker system, in an embodiment of the present invention. At step 1200, a stocker may be provided that may be configured to store substrates in at least one compartment or container and a container or compartment in the stocker may be marked to be cleaned. At step 1201, the container or compartment marked to be cleaned may be emptied of substrates by a robot. Further, at step 1202 the container or compartment may be detached from the stocker and placed on a dock cart. At step 1203 the container or compartment removed may be replaced from a previously cleaned or new compartment or container from the cart or other source to provide low downtime. At step 1204 the cart provides a cleaning solution for flooding the container or compartment. At step 1205, the container or compartment may be emptied of the cleaning solution and at step 1206, the container or compartment after being cleaned may be stored on the cart and replaced on a stocker to stock substrates when needed.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments may be within the scope of the following claims.

What is claimed is:

1. A substrate stocker system, comprising:
one or more high density storage chamber that comprises a plurality of compartments, each storing one or more high density carriers and substrates;
one or more robots configured to move one or more compartments of the high density storage chamber,
one or more cleaning modules configured to clean the one or more compartments,
one or more transport mechanism for moving the one or more compartments to or from the one or more cleaning modules for cleaning,
wherein the transport mechanism is one or more robots.

2. The substrate stocker system as claimed in claim 1, wherein at least an opener station and transport mechanism is able to open or close the high density container, such that substrates and carriers are able to be moved to or from the container, wherein then the container is emptied prior to cleaning or filled after cleaning.

3. The substrate stocker system as claimed in claim 1, wherein the cleaning module is interior or exterior to the stocker system.

4. The substrate stocker system as claimed in claim 1, wherein the cleaning module performs cleaning of one or more compartments using at least one of: a cleaning solution, an external heater, pressurized air, an internal heater, a sonic vibrator, and an ultrasonic vibrator.

5. The substrate stocker system as claimed in claim 4, wherein the cleaning solution is selected from at least one of: acetone, methanol, ammonium hydroxide, hydrogen peroxide, hydrofluoric acid and water.

6. The substrate stocker system as claimed in claim 4, wherein the cleaning module includes a dock cart, wherein
the compartment is able to be moved to the dock cart,
the dock cart cleans the compartment,
the compartment is able to be moved back to the high density storage chamber, and
the dock cart includes at least one of: a reservoir of a cleaning solution pressurized air, heater, and sonic or ultrasonic vibrator.

7. The substrate stocker system as claimed in claim 1, wherein the cleaning module comprises:
one or more sensors for tracking cleaning of the one or more compartments, wherein the one or more sensors are selected from at least one of: a temperature sensor, a liquid sensor, a pressure sensor, and an optical sensor; and
a controller communicatively coupled to the one or more sensors for automating a cleaning regime of the one or more compartments, wherein the controller is configured to automatically set at least one of: an optimal temperature, a quantity of cleaning solution, and a cleaning time.

8. The substrate stocker system as claimed in claim 1, wherein each compartment has a door that is operable to be sealed to hold a cleaning solution and opened such that the carriers and substrates can be accessed.

9. The substrate stocker system as claimed in claim 4, wherein the external and internal heaters are configured to heat a compartment to a temperature ranging from 80 to 100 degree centigrade to aid in the vapor cleaning and drying of the compartment.

10. The substrate stocker system as claimed in claim 4, wherein the cleaning module includes one or more nozzles for spraying the cleaning solution into a compartment.

11. The substrate stocker system as claimed in claim 4, wherein the cleaning module comprises a filtering module for filtering the cleaning solution that is drained out of a compartment after cleaning to be reused, recycled or disposed.

12. A method of cleaning a substrate stocker system, the substrate stocker system including a high density storage chamber that includes one or more compartments, each storing one or more high density substrates, the method comprising:
emptying one or more compartment of one or more high density substrates by one or more robots;
flooding the compartment with a cleaning solution till a predefined height;
soaking the compartment with a cleaning solution for a predefined time period;
draining out the cleaning solution from the compartment; and
stocking the cleaned compartment with the one or more high density substrates.

13. The method as claimed in claim 12 further comprising:
transferring an uncleaned compartment from the high density storage chamber to a dock cart; and
transferring a previously cleaned container from the dock cart to the high density storage container.

14. The method as claimed in claim 12, further comprising:
wherein after emptying the compartment,
one or more compartments are transferred from the high density storage chamber to a dock cart;
wherein the flooding, soaking and draining are performed at and by the cart, and additionally using one or more of a cleaning solution, heater, and ultrasonic vibrator; and
transferring back the one or more cleaned compartment in the high density storage chamber.

15. The method as claimed in claim 14 further comprising:
wherein the dock cart is able to hold more than one compartment, wherein the cart can facilitate each compartment cleaning process separately such that a previously cleaned compartment can be transferring back to the high density storage chamber on receipt of a uncleaned container.

16. The method as claimed in claim 12 further comprising:
transferring an uncleaned compartment from the high density storage chamber to a load port,
transferring the compartment from the load port to the exterior cleaning location for cleaning; and
refilling the high density storage chamber container location with another cleaned compartment.

17. The method as claimed in claim 16 further comprising:
wherein the other cleaned compartment is from the load port and exterior cleaning location.

18. The method as claimed in claim 16 further comprising:
wherein the other cleaned compartment is from one of: another storage location, an OHT, an opener station, a loading station, another cleaning location.

19. The method as claimed in claim 12 further comprising:
wherein the cleaning of the compartment is facilitated in place in the high density storage chamber, wherein the cleaning of the compartment is facilitated interior to the stocking system.

20. The method as claimed in claim 12 further comprising:
wherein the cleaning of the compartment is facilitated interior to the stocking system.
